(19) United States
(12) Patent Application Publication
(10) Pub. No.: US 2026/0246196 A1
(43) Pub. Date: Aug. 20, 2026

(54) CONNECTOR

(71) Applicant: SUMITOMO WIRING SYSTEMS, LTD., Mie (JP)

(72) Inventors: Takaya GOTO, Mie (JP); Yuta INOUE, Mie (JP)

(21) Appl. No.: 19/538,475

(22) Filed: Feb. 12, 2026

(30) Foreign Application Priority Data
Feb. 19, 2025 (JP) 2025-024757

(51) Int. Cl. H01R 13/52; H01R 13/41; H01R 13/627; H01R 13/629

(52) U.S. Cl. CPC H01R 13/5219; H01R 13/41; H01R 13/6272; H01R 13/62938; H01R 13/62955; H01R 13/62977

(57) ABSTRACT

A connector includes a first connector and a second connector. The first connector includes a first housing and a lever including cam plates. The second connector includes a second housing, a portion of which is disposed in a tubular portion of a case. The first housing includes a first housing body, an extended portion extending outward from a leading end portion of the first housing body, and a peripheral wall portion protruding in a mating direction from an outer end portion of the extended portion. The tubular portion is disposed in the inner side of the peripheral wall portion and forward of the extended portion in the mating direction. The first housing includes upright walls protruding in the direction opposite to the mating direction from the outer end portion of the extended portion. The cam plates are each disposed between the first housing body and the corresponding upright walls.

### CROSS-REFERENCE TO RELATED APPLICATIONS

This application is based on and claims priority from Japanese Patent Application No. 2025-024757, filed on February 19, 2025, with the Japan Patent Office, the disclosure of which is incorporated herein in its entirety by reference.

### TECHNICAL FIELD

The present disclosure relates to a connector.

### BACKGROUND

The connector described in JP 2024-135324 A includes a housing that is mateable with a mating connector and a lever rotatably supported by the housing. The housing has an outer wall portion and an extended wall portion extending outward from the outer wall portion. A through groove is formed in the outer wall portion, and a through hole is formed in the extended wall portion. A cam groove is formed in the lever. The mating connector includes a cam pin that engages with the cam groove through the through groove and the through hole.

### SUMMARY

When the lever is being operated, a force that causes the lever to open outward acts on the lever. In this case, if a structure for preventing the lever from opening is newly added to the connector, there is a risk that the structure of the housing will become complicated or increase in size.

In view of this, an object of the present disclosure is to provide a connector that can prevent a lever from opening when the lever is being operated, while simplifying the structure of a housing.

A connector according to the present disclosure includes: a first connector; and a second connector, wherein the first connector includes a first housing and a lever rotatably supported by the first housing, the second connector includes a second housing that is mateable with the first housing, the lever includes a cum plate that engages with the second housing, a portion of the second housing is disposed inside a tubular portion of a case, the first housing includes a housing body, an extended portion extending outward from a leading end portion of the housing body in a mating direction of the first housing, and a peripheral wall portion protruding in the mating direction from an outer end portion of the extended portion, the tubular portion is disposed in a space on an inner side of the peripheral wall portion and forward of the extended portion in the mating direction, the first housing has an upright wall protruding from the outer end portion of the extended portion in a direction opposite to the mating direction, and the cam plate is disposed to be sandwiched between the upright wall and the housing body.

According to the present disclosure, it is possible to provide a connector that can prevent a lever from opening when the lever is being operated, while simplifying the structure of a housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector according to a first embodiment.

FIG. 2 is an exploded perspective view of the connector according to the first embodiment.

FIG. 3 is a cross-sectional view showing a mated state of a first connector and a second connector, in the connector according to the first embodiment.

FIG. 4 is a side view of a first housing of the connector according to the first embodiment.

FIG. 5 is a bottom view of the first housing of the connector according to the first embodiment.

FIG. 6 is a plan view of the first housing of the connector according to the first embodiment.

FIG. 7 is a side view showing a state where a lever is disposed above the first housing before the lever is attached to the first housing, in the connector according to the first embodiment.

FIG. 8 is a perspective view showing a state where upright walls are disposed outward of a cam plate and face the cam plate, in the connector according to the first embodiment.

FIG. 9 is a side view showing a state at the time of a start of mating between the first connector and the second connector, in the connector according to the first embodiment.

FIG. 10 is a side view showing a state at the time of completion of mating between the first connector and the second connector, in the connector according to the first embodiment.

FIG. 11 is a diagram in which an electric wire cover, in which the orientation of an electric wire drawing portion has been changed, is provided in the connector according to the first embodiment, the diagram corresponding to FIG. 9.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

(1) A connector according to the present disclosure includes: a first connector; and a second connector, wherein the first connector includes a first housing and a lever rotatably supported by the first housing, the second connector includes a second housing that is mateable with the first housing, the lever includes a cum plate that engages with the second housing, a portion of the second housing is disposed inside a tubular portion of a case, the first housing includes a housing body, an extended portion extending outward from a leading end portion of the housing body in a mating direction of the first housing, and a peripheral wall portion protruding in the mating direction from an outer end portion of the extended portion, the tubular portion is disposed in a space on an inner side of the peripheral wall portion and forward of the extended portion in the mating direction, the first housing has an upright wall protruding from the outer end portion of the extended portion in a direction opposite to the mating direction, and the cam plate is disposed to be sandwiched between the upright wall and the housing body.

When the first connector and the second connector are mated with each other, outward deformation of the cam plate can be suppressed by the upright wall. The upright wall protrudes from the extended portion. The extended portion and the peripheral wall portion constitute a part that is mated with the case. Thus, with the configuration of above (1), the extended portion can constitute a part that exhibits a function of preventing the lever from opening and a function of mating with the case, and thus the structure can be simplified compared with a case where separate structures are provided for the respective functions.

(2) In the connector according above (1), preferably, the cam plate engages with a cam pin of the second housing, a through hole into which the cam pin is inserted is formed in the extended portion, a pair of upright walls are disposed on opposite sides of the through hole, and the cam plate is disposed to be sandwiched between the housing body and the pair of upright walls during an entire rotation process of the lever from a start of mating between the first housing and the second housing to completion of the mating.

With the configuration of above (2), the pair of upright walls are both provided at positions where the upright walls can prevent the cam plate from opening outward, and thus, for example, the rotation angle of the lever is limited, making it possible to handle a situation where a large opening force (a force acting to open the cam plate outward) acts on the cam plate.

(3) In the connector according above (2), preferably, each of the upright walls gradually narrows in width from a base end thereof connected to the extended portion to a leading end in a protruding direction.

With the configuration of above (3), the upright walls are each shaped such that the width of the base end is larger than the leading end, and thus the strength of the upright walls can be ensured. In addition, due to the shape of the upright walls that narrow in width, it is possible to easily achieve settings that can avoid interference between the lever and the upright walls.

(4) In the connector according to any one of above (1) to (3), preferably, outer surfaces of the upright walls are formed along an arc shape of an outer peripheral surface of the peripheral wall portion as viewed in the mating direction, and inner surfaces of the upright walls are formed linearly along a direction orthogonal to the mating direction as viewed in the mating direction.

With the configuration of above (4), compared with a case where the outer surfaces of the upright walls are formed linearly along a direction orthogonal to the mating direction, the thickness of the upright walls can be increased, and thus the strength of the upright walls can be improved.

### Detailed Description of Embodiments of the Present Disclosure

Specific examples of embodiment of the present disclosure will be described below with reference to the drawings. Note that the present invention is not limited to these illustrations, but is indicated by the claims, and is intended to include all modifications that are within the meanings and the scope that are equivalent to those of the claims.

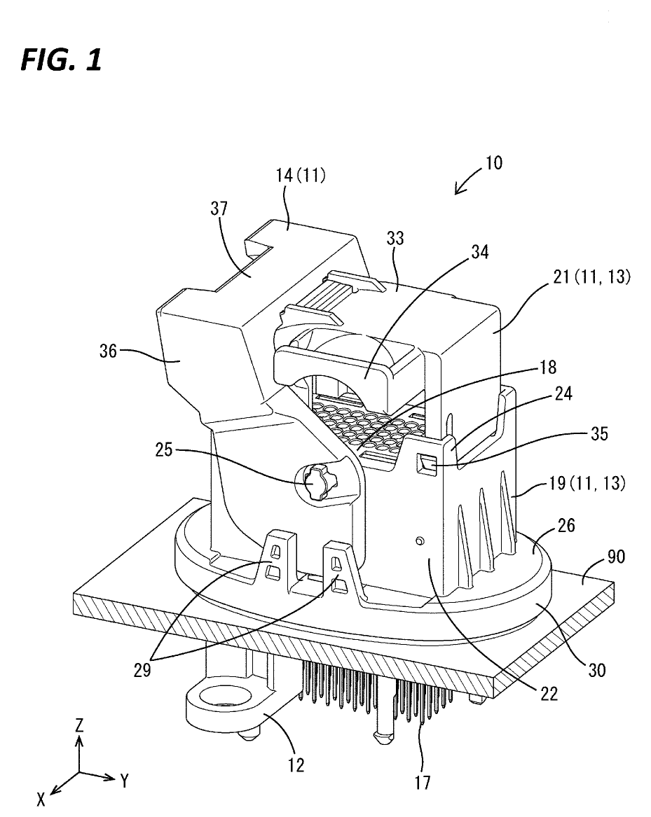

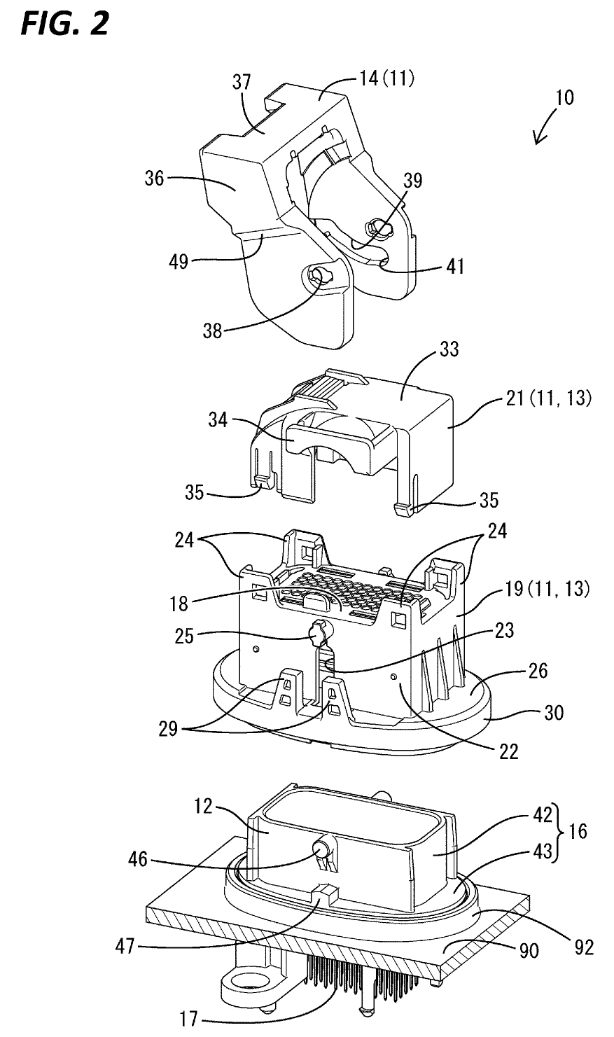

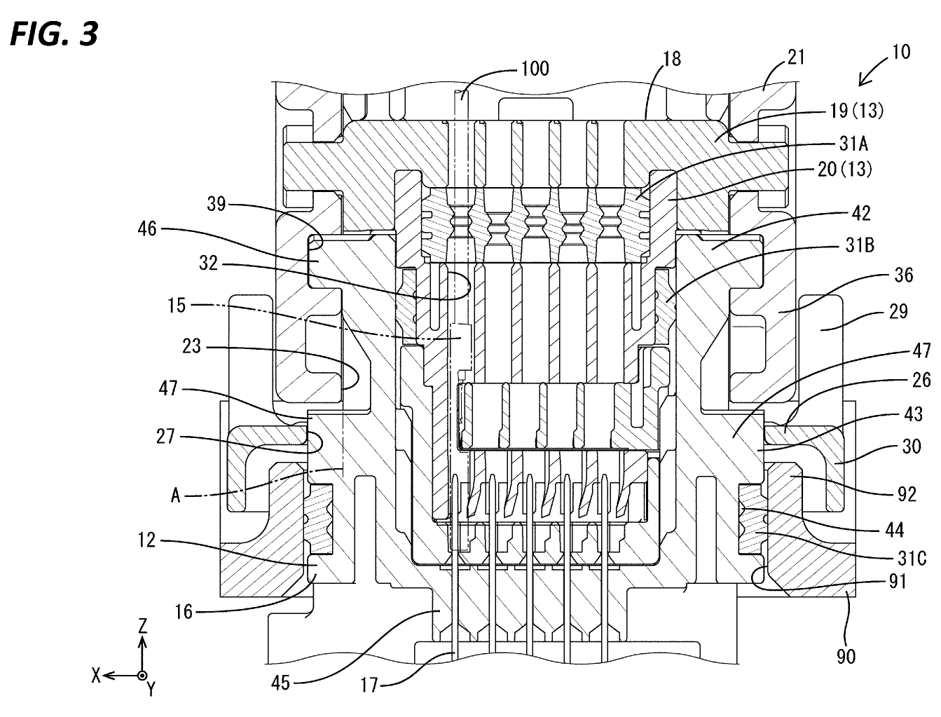

As shown in FIGS. 1 and 2, a connector 10 according to a first embodiment includes a first connector 11 and a second connector 12 that are mateable with each other. In the first embodiment, the first connector 11 is a female connector, and the second connector 12 is a male connector. The first connector 11 includes a first housing 13, and a lever 14 that is rotatably supported by the first housing 13. As shown in FIG. 3, the first housing 13 accommodates a plurality of first terminal fittings 15 that are female terminals (for convenience of illustration, only one first terminal fitting 15 is illustrated). The second connector 12 includes a second housing 16, and a plurality of second terminal fittings 17 that are male terminals and are accommodated in the second housing 16. Note that, in the following description, the up-down direction is equivalent to the mating direction of the first connector 11 and the second connector 12, and the second connector 12 is mated with the first connector 11 from below. Reference sign Z in FIG. 1 indicates an upward direction. Reference signs X and Y in FIG. 1 indicate a rightward direction and a frontward direction, respectively. In addition, in the following description, unless otherwise specified, an "inner side" refers to a side approaching the center of the connector 10, and an "outer side" refers to a side separating away from the center of the connector 10.

### First Embodiment

The connector 10 is a waterproof connector to be mounted in an automobile or the like. As shown in FIG. 2, the second connector 12 is fixed to a case 90. Although the overall shape of the case 90 is not illustrated, the case 90 is box shaped. For convenience of illustration, only a portion of the case 90 is shown in the drawings. The case 90 is made of metal by aluminium die casting or the like. As shown in FIG. 3, the case 90 includes an opening portion 91 extending through the upper wall of the case 90 in the up-down direction, and a tubular portion 92 protruding upward from the entire periphery of the opening portion 91. An upper end edge of the tubular portion 92 has an oblong shape when viewed from above.

### First Connector 11

The first connector 11 and the second connector 12 are mated with each other by rotating the lever 14. The first terminal fittings 15 are made of conductive metal. As shown in FIG. 3, an electric wire 100 is connected to the first terminal fittings 15. The electric wires 100 are drawn out upward from an electric wire drawing surface 18 that is an upper surface of a later-described outer housing 19 of the first housing 13.

The first housing 13 includes the outer housing 19, an inner housing 20 that is accommodated in the outer housing 19, and an electric wire cover 21 that is mounted to the outer housing 19 from above. The outer housing 19, the inner housing 20, and the electric wire cover 21 are all made of a synthetic resin.

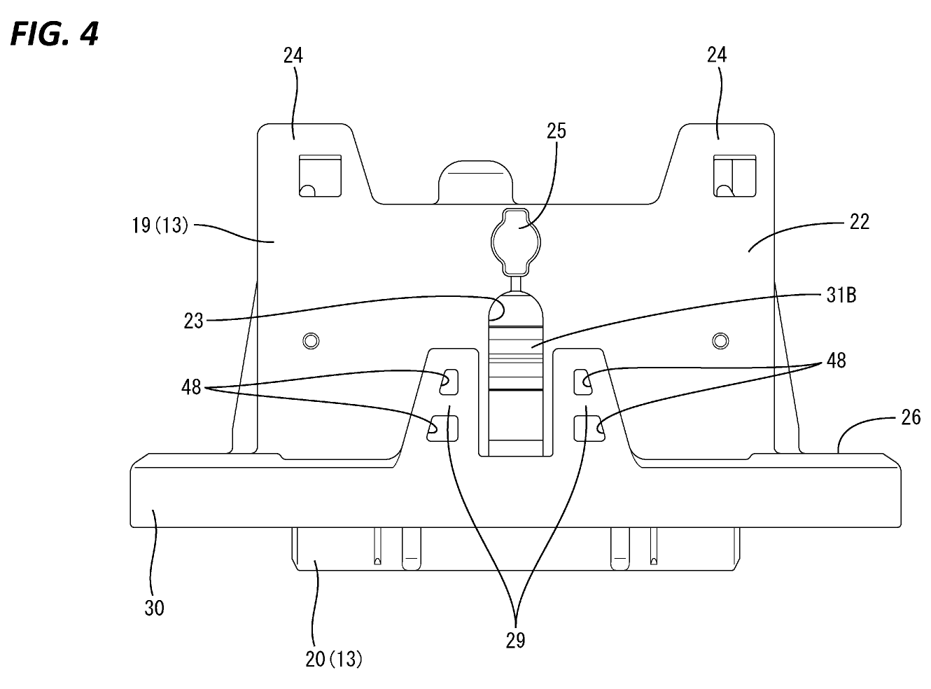

As shown in FIGS. 2 and 4, the outer housing 19 has a first housing body 22 (housing body). The first housing body 22 is formed in a rectangular tubular shape by an upper wall, a front wall, a rear wall, a right wall, and a left wall. The electric wire drawing surface 18 is formed on the upper wall. The first housing body 22 has a plurality of through grooves 23 through which later-described cam spins 46 of the second connector 12 are inserted. In the first embodiment, the through grooves 23 are respectively provided at intermediate portions in the front-rear direction of the left and right walls of the first housing body 22. The through grooves 23 extend through the first housing body 22 in the wall thickness direction (left-right direction, in-out direction) thereof. The through grooves 23 extend in the up-down direction. Lower ends of the through grooves 23 are open in lower end portions of both the left and right walls of the first housing body 22. On both the left and right walls of the first housing body 22, upper ends of the through grooves are closed at positions lower than support shafts 25 to be described later (see FIG. 4). At the four corners of an upper end portion of the first housing body 22, respective cover lock receiving portions 24, to which the electric wire cover 21 is mounted, are provided to protrude upward.

The support shafts 25 are respectively provided to protrude outward from both the left and right walls of the first housing body 22 (for convenience of illustration, only the support shaft 25 on one of the left and right sides is illustrated). The support shafts 25 are respectively fitted into later-described shaft holes 38 of the lever 14. The support shafts 25 rotatably support the lever 14.

The outer housing 19 also has an extended portion 26 extending outward from a lower end portion of the first housing body 22. The extended portion 26 has an oblong shape longer in the front-rear direction than in the left-right direction as viewed from above. The extended portion 26 is formed in a flat plate shape extending in the front-rear direction and the left-right direction. The extended portion 26 is disposed to face an upper end edge of the tubular portion 92 of the case 90 in the mated state between the first connector 11 and the second connector 12.

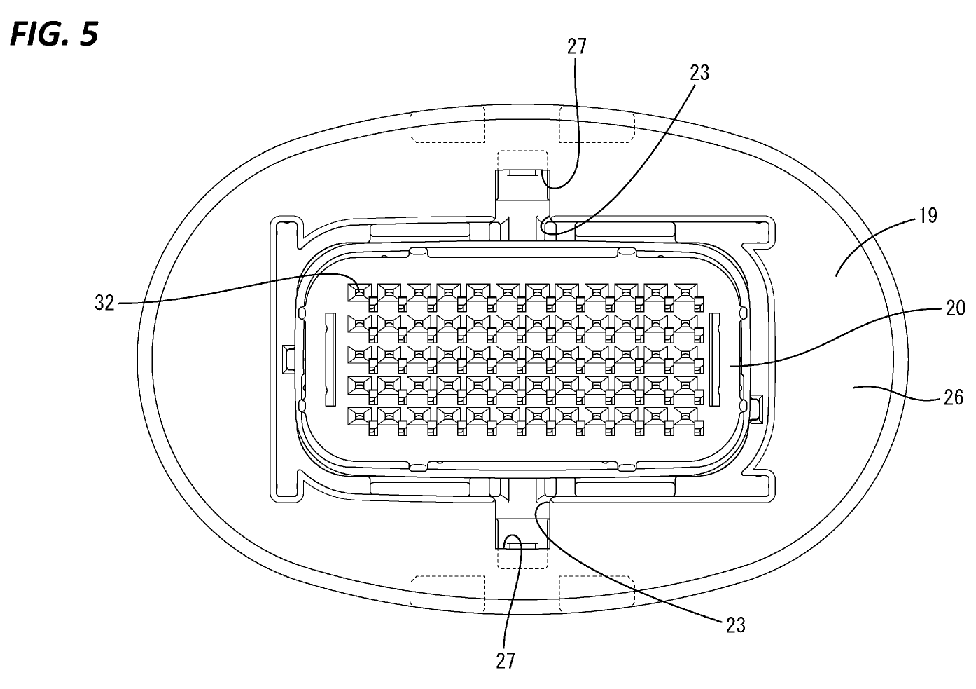

Through holes 27 that are respectively in communication with lower end portions of the through grooves 23 are provided at intermediate portions in the front-rear direction of the extended portion 26. The extended portion 26 extends outward from the lower end portion of the first housing body 22, and thus the through holes 27 are disposed outward of the through grooves 23 (see the one-dot chain line A in FIG. 3. The one-dot chain line A is a reference line that separates the lower end portions of the through groove 23 and the through hole 27 into inner and outer sides). The through holes 27 extend through the extended portion 26 in the plate thickness direction (up-down direction). As shown in FIG. 5, the through holes 27 have a rectangular hole edge shape as viewed from below. Hole edges at right and left end portions of through holes 27 are formed to extend in the front-rear direction. Hole edges at front and rear end portions of the through holes 27 are formed to extend in the left-right direction.

The outer housing 19 has a peripheral wall portion 30 that protrudes downward from an outer peripheral edge of the extended portion 26 over the entire periphery. The peripheral wall portion 30 has an oblong shape longer in the front-rear direction than in the left-right direction as viewed from below. The peripheral wall portion 30 is mated with the tubular portion 92 from outside, in a state where the first connector 11 and the second connector 12 are mated with each other.

On the outer peripheral edge of the extended portion 26, a plurality of upright walls 29 protruding upward are provided. As shown in FIGS. 2 and 4, the upright walls 29 have a plate shape, and a pair of front and rear upright walls 29 are provided on each of the left and right end portions of the outer peripheral edge of the extended portion 26 (FIG. 4 only illustrates the upright walls 29 on one of the left and right sides). The pair of upright walls 29 provided in the front-rear direction are disposed on front and rear sides of the through groove 23 and the through hole 27. In a state where the lever 14 is mounted to the outer housing 19, later-described cam plates 36 of the lever 14 are each sandwiched between the first housing body 22 and the upright walls 29, and the upright walls 29 face the outer surface of the cam plate 36.

Upper ends of the upright walls 29 are arranged horizontally along the front-rear direction. Base ends of the upright walls 29 are connected to the extended portion 26. The outer surfaces of the upright walls 29 are continuous with and flush with the outer surface of the peripheral wall portion 30. The inner surfaces of the upright walls 29 face the outer surface of the cam plate 36 in parallel. The inner end surfaces in the front-rear direction of the pair of upright walls 29 (end surfaces facing each other) stand upright from the extended portion 26, and are disposed along the up-down direction. The outer end surfaces in the front-rear direction of the pair of upright walls 29 stand upright from the extended portion 26, and are inclined inward in the front-rear direction toward the top. Thus, the upright walls 29 gradually narrow in width from the base ends connected to the extended portion 26 to the upper ends.

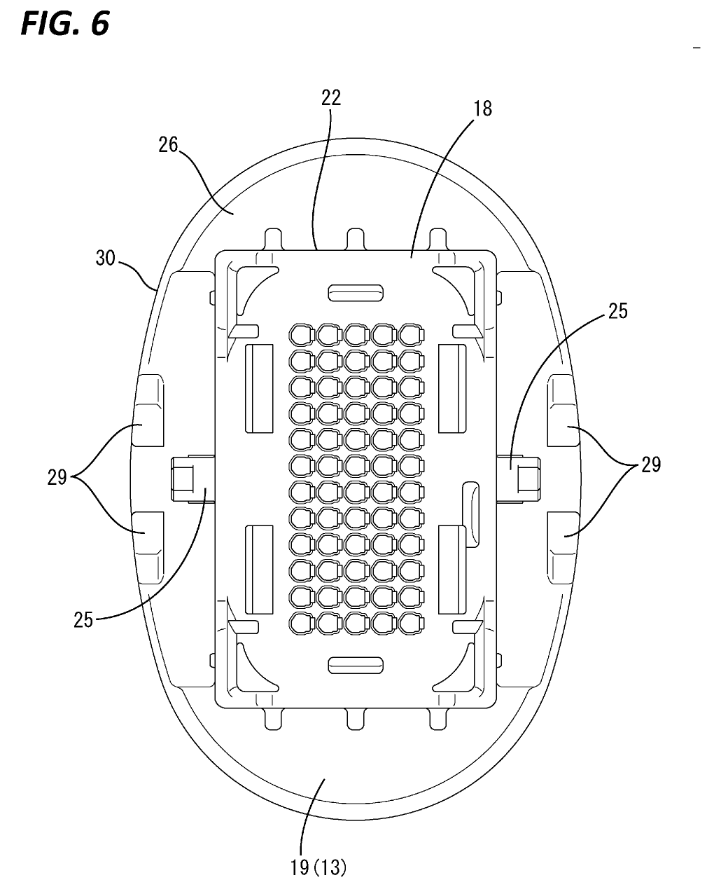

As shown in FIG. 6, the outer surfaces of the upright walls 29 are formed along the arc shape of the outer peripheral surface of the peripheral wall portion 30 as viewed from above. The inner surfaces of the upright walls 29 are formed linearly along the front-rear direction as viewed from above. Accordingly, the plate thickness of the upright walls 29 gradually increases from the outer side to the inner side in the front-rear direction. As shown in FIG. 4, two recesses 48 arranged in the up-down direction are provided in the outer surface of each of the upright walls 29. Due to the shape of the upright wall 29 that narrows in width as described above, the upper recess 48 has a narrower shape than the lower recess 48.

As described above, the inner housing 20 is accommodated and held in the first housing body 22 of the outer housing 19. A seal member 31A is disposed to be sandwiched between the inner housing 20 and the outer housing 19 in the up-down direction. The seal member 31A maintains a liquid-tight state between the inner housing 20 and the outer housing 19, and around the electric wires 100 connected to the first terminal fittings 15. The inner housing 20 is fitted into a later-described second housing body 42 of the second connector 12. A seal member 31B is mounted on the outer peripheral surface of the inner housing 20. In the mated state between the inner housing 20 and the second housing body 42, the seal member 31B is in intimate contact with the outer peripheral surface of the inner housing 20 and the inner peripheral surface of the second housing body 42. The seal member 31B maintains a liquid-tight state between the first housing 13 and the second housing 16.

As shown in FIG. 5, the inner housing 20 is provided with a plurality of cavities 32 extending therethrough in the up-down direction. The cavities 32 are arranged in multiple columns in the front-rear direction and in multiple rows in the left-right direction. The first terminal fittings 15 are respectively inserted into the cavities 32 from above. In the mated state between the first connector 11 and the second connector 12, the first terminal fittings 15 are connected to the second terminal fittings 17, respectively.

As shown in FIG. 2, the electric wire cover 21 includes a back wall 33 facing the electric wire drawing surface 18 from above with a gap therebetween, an electric wire drawing portion 34 protruding rightward from the back wall 33, and pairs of front and rear cover lock portions 35 protruding downward from the back wall 33 and respectively provided on the left side and right side. The back wall 33 and the electric wire drawing portion 34 serve to guide the electric wires 100 from the electric wire drawing surface 18 in the rightward direction as illustrated. The electric wire cover 21 is mounted to the outer housing 19 when the cover lock portions 35 lock to the corresponding cover lock receiving portions 24 of the outer housing 19.

Although not illustrated, a lever lock receiving portion is provided at a rear end portion of the back wall 33. When a later-described lever lock portion of the lever 14 locks in the lever lock receiving portion, rotation of the lever 14 is suppressed at a mating completion position to be described later.

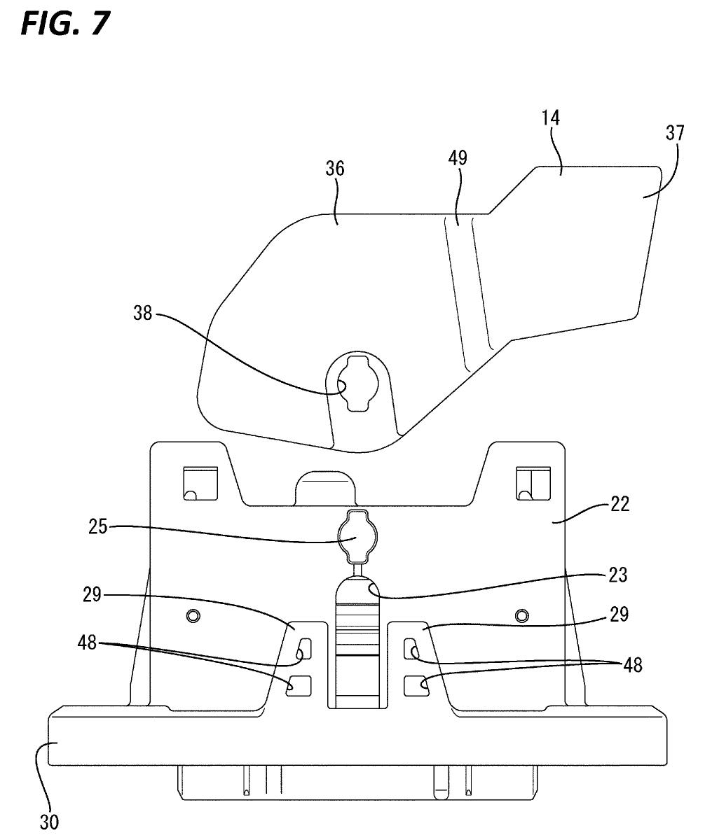

The lever 14 includes a pair of cam plates 36 having a flat plate shape and a coupling portion 37 that couples the cam plates 36. The cam plates 36 are disposed with their plate surfaces oriented in the left–right direction. The cam plates 36 respectively have shaft holes 38 extending therethrough in the plate thickness direction and cam grooves 39 recessed in the inner surfaces of the cam plates 36. The shaft holes 38 are circular through holes. In a state where the lever 14 is mounted to the outer housing 19, the shaft holes 38 respectively receive the support shaft 25. A lower end of the coupling portion 37 in FIG. 2 serves as the lever lock portion that is locked to the lever lock receiving portion. The outer surface of each cam plate 36 is provided with an inclined surface 49 inclined outward in the left–right direction from a thin portion having the shaft hole 38 toward a thick portion contiguous with the coupling portion 37 (see FIGS. 2 and 7).

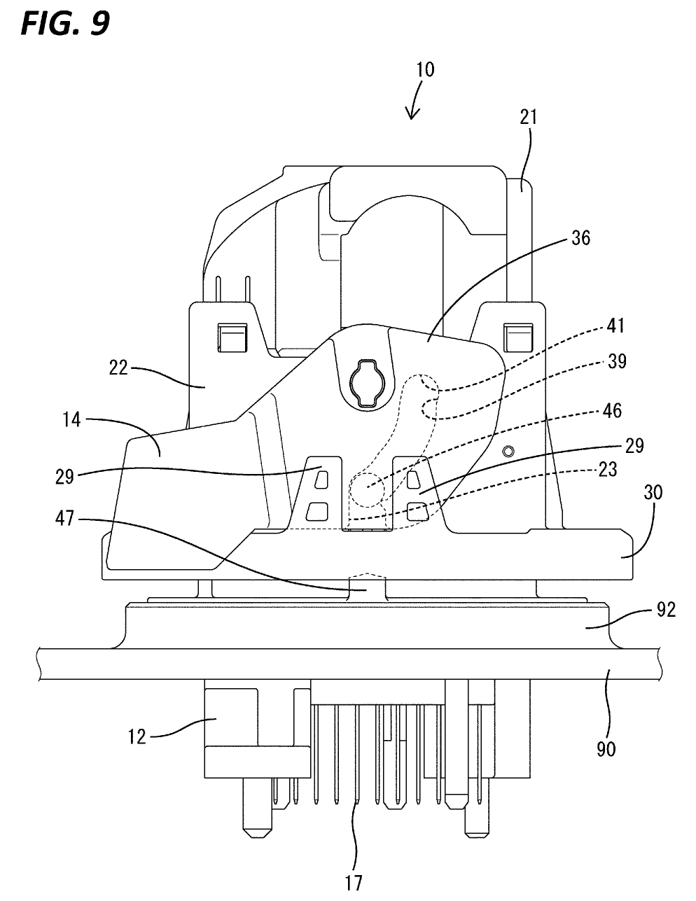

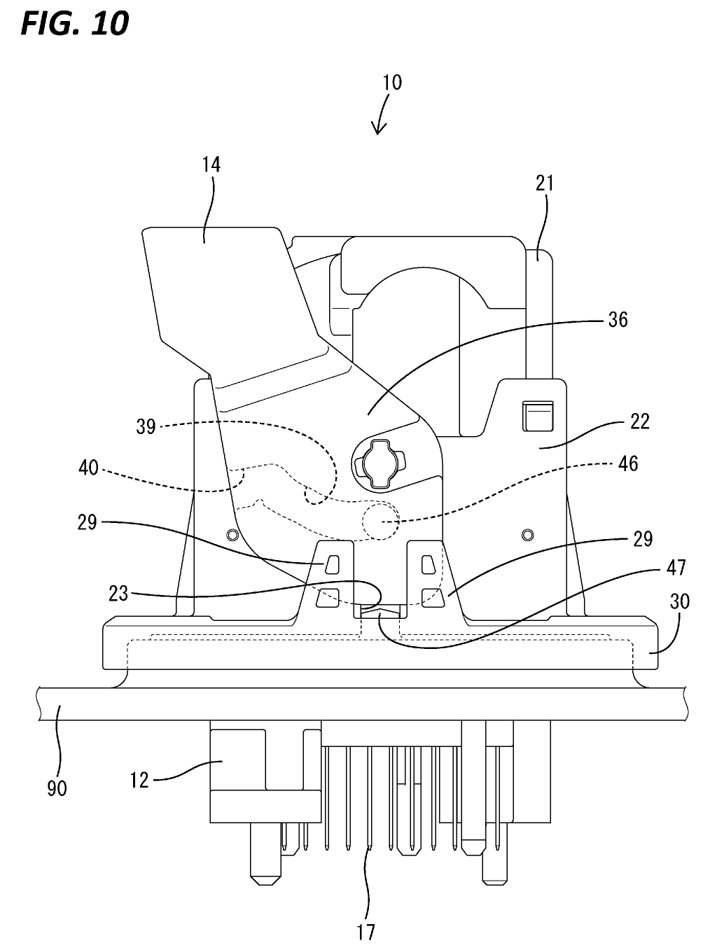

The cam grooves 39 receive the cam pins 46 of the second connector 12. Each cam groove 39 has a cam entry port 40 that allows entry of the cam pin 46. The cam groove 39 extends from the cam entry port 40 to a cam rear end 41, which is a distal end of the cam groove. The cam groove 39 is curved from the cam entry port 40 to the cam rear end 41 (see FIGS. 9 and 10).

### Second Connector 12

The second connector 12 is mated with the first connector 11 from below. As described above, the second connector 12 includes the second housing 16, and the plurality of second terminal fittings 17 that are accommodated in the second housing 16. The second terminal fittings 17 are made of conductive metal. The second terminal fittings 17 have a pin shape that extends in the up-down direction. The second terminal fittings 17 are mounted to a later-described terminal holding portion 45 of the second housing 16 (see FIG. 3). Lower portions of the second terminal fittings 17 protrude downward from the second housing 16, and are connected to a circuit board (not illustrated).

The second housing 16 includes the second housing body 42 having a rectangular tubular shape, and a case mating portion 43 extending outward from a lower end of the second housing body 42. The case mating portion 43 has an oblong shape longer in the front-rear direction than in the left-right direction as viewed from above. As shown in FIG. 3, a seal mount portion 44 is provided in an outer peripheral surface of the case mating portion 43. The seal mount portion 44 is recessed over the entire periphery of the outer peripheral surface of the case mating portion 43. A seal member 31C made of rubber is mounted to the seal mount portion 44. In a state where the second connector 12 is fixed to the case 90, the seal member 31C is in intimate contact with an inner peripheral surface of the tubular portion 92 and the outer peripheral surface of the case mating portion 43 in a liquid-tight manner.

The second housing body 42 is formed in a rectangular tubular shape that is open upward. The terminal holding portion 45 of the second housing body 42 is a portion that forms a bottom wall of the second housing body 42. Upper ends of the second terminal fittings 17 extend through the terminal holding portion 45 and protrude inward from the second housing body 42. In the mated state between the first connector 11 and the second connector 12, the second housing body 42 is mated between the first housing body 22 and the inner housing 20.

The cam pins 46 are provided to protrude outward from upper end portions of both the left and right walls of the second housing body 42, respectively. The cam pins 46 have a cylindrical shape. During the mating process between the first connector 11 and the second connector 12, the cam pins 46 are fitted into the through grooves 23 through the through holes 27.

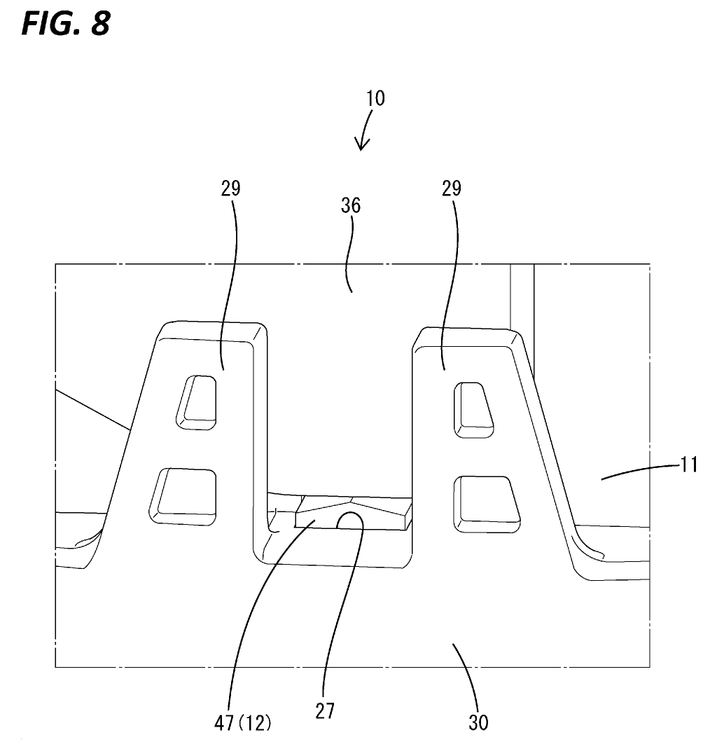

Blocking portions 47 are respectively provided to protrude outward from lower end portions of both the left and right walls of the second housing body 42. In the mating state between the first connector 11 and the second connector 12, the blocking portions 47 are disposed to block the lower end portions of the through grooves 23 and the through holes 27. The blocking portions 47 are disposed coaxially with the cam pins 46 in the up-down direction, respectively. The blocking portions 47 and the cam pins 46 all protrude from the outer surfaces of the left and right walls of the second housing body 42 that extend along the up-down direction and the front-rear direction. As shown in FIG. 8, in the state where the first connector 11 and the second connector 12 are mated with each other, a portion of each blocking portion 47 is visible from between the pair of upright walls 29.

### Operation of Attaching Lever 14

An operation of attaching the lever 14 to the outer housing 19 will be described. As shown in FIG. 7, in an orientation where the coupling portion 37 of the lever 14 faces forward and the shaft holes 38 are positioned above the support shafts 25 in the up-down direction, the lever 14 is inserted between the left wall of the first housing body 22 and the corresponding upright walls 29 and between the right wall and the corresponding upright walls 29 from above. During insertion of the lever 14 between the left wall of the first housing body 22 and the corresponding upright walls 29 and between the right wall and the corresponding upright walls 29, the cam plates 36 deform so as to open outward as the cam plates 36 respectively abut on the support shafts 25. Thereafter, when the support shafts 25 are respectively fitted into the shaft holes 38, opening of the cam plates 36 is released. The upper end positions of the upright walls 29 are set such that the upright walls 29 do not interfere with the cam plates 36 even if the cam plates 36 open outward during the process of attaching the lever 14 to the outer housing 19 as described above. The lever 14 is rotated 180 degrees about the support shafts 25 such that the coupling portion 37 moves to the rear side (see the lever 14 at an initial mating position in FIG. 9). As described above, since the leading ends of the lever 14 are formed to be narrower in width, interference between the upright walls 29 and the inclined surfaces 49 of the lever 14 can be avoided even when the lever 14 is at the initial mating position.

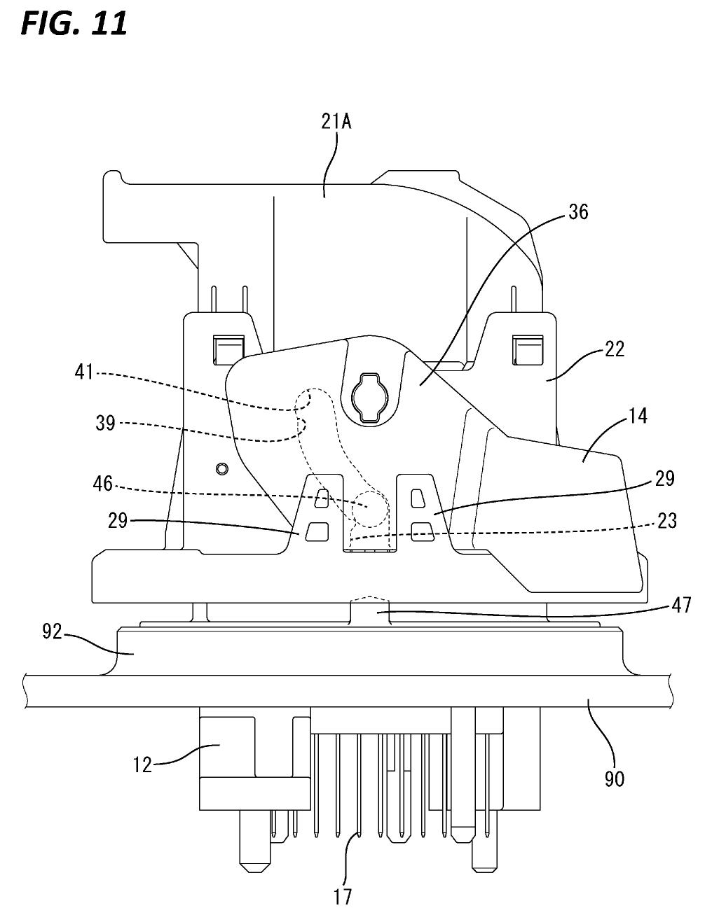

In the first embodiment, the lever 14 can be attached to the outer housing 19 with the attachment orientation of the lever 14 reversed left-to-right relative to FIG. 7. In this case, as shown in FIG. 11, by attaching an electric wire cover 21A having a shape different from that of the electric wire cover 21 to the outer housing 19, the drawing direction of the electric wires can be changed from that of the first embodiment. That is, even when the shape of the electric wire cover differs from that of the first embodiment, the lever 14 can be used without changing the shape thereof.

### Operation of Mating First Connector 11 and Second Connector 12

Next, an operation of mating the first connector 11 and the second connector 12 with each other will be described. At the start of mating between the first connector 11 and the second connector 12, the cam entry ports 40 are disposed to come into communication with the lower end portions of the through grooves 23, and come into communication with the through holes 27 in the up-down direction, while facing downward. In this state, the first connector 11 and the second connector 12 are shallowly mated with each other (see FIG. 9). As a result, leading ends of the cam pins 46 enter the cam entry ports 40 through the through holes 27, respectively. Base ends of the cam pins 46 enter the lower end portions of the through grooves 23, respectively. The coupling portion 37 is positioned rearward of the first housing body 22.

Next, while the coupling portion 37 is griped, the lever 14 is rotated about the support shafts 25 toward a mating completion position. During the rotation process of the lever 14, the cam pins 46 slide along the surfaces of the cam grooves 39 toward cam rear ends 41. The first connector 11 and the second connector 12 are drawn toward each other by the cam action between the lever 14 and the second connector 12. In the process of moving the lever 14 from the mating start position to the mating completion position, outer peripheral edges of the cam plates 36 are positioned apart from the blocking portions 47.

During the rotation process of the lever 14, an expanding force for opening the cam plates 36 outward in the left-right direction acts on the cam plates 36. The mating force between the connectors 11 and 12 increases as the angle of rotation of the lever 14 is limited, resulting in an increase in the expanding force. In the first embodiment, during the entire rotation process of the lever 14 from the initial mating position to the mating completion position, the pair of upright walls 29 on the opposite sides of each through hole 27 face the corresponding cam plate 36 in a contactable manner. For this reason, for example, even when the angle of rotation of the lever 14 is limited and the expanding force acting on the cam plates 36 becomes large, the upright walls 29 can maximally prevent the cam plates 36 from opening. Note that, in the first embodiment, the angle of rotation of the lever 14 from the initial mating position to the mating completion position is preferably 60 to 90°, more preferably 70 to 85°, and in the illustrated example, 80°.

The base ends of the upright walls 29 connected to the extended portion 26 are wider than the leading ends of the upright walls 29, and thus the strength of the upright walls 29 can be secured. In addition, as shown in FIG. 6, the outer surfaces of the upright walls 29 are formed along the arc shape of the outer peripheral surface of the peripheral wall portion 30 as viewed from above. Furthermore, the inner surfaces of the upright walls 29 are formed linearly along the front-rear direction as viewed from above. Accordingly, compared with a case where the outer surfaces of the upright walls are formed linearly along the front-rear direction, the plate thickness of the upright walls 29 can be increased, and thus the strength of the upright walls 29 can be improved.

When the lever 14 is at a position where the cam pins 46 reach the cam rear ends 41, that is, the mating completion position, the lever lock portion of the lever 14 locks to the lever lock receiving portion of the electric wire cover 21. Accordingly, rotation of the lever 14 is limited, and, at the same time, the first connector 11 and the second connector 12 are held in the mated state (see FIG. 10).

In the mated state between the first connector 11 and the second connector 12, the tubular portion 92 of the case 90 is disposed in a space on the inner side of the peripheral wall portion 30 and below the extended portion 26, and, even when the first connector 11 is exposed to water, water is drained along the extended portion 26 and the peripheral wall portion 30, making it possible to prevent the second connector 12 from being exposed to water (see FIG. 3). Furthermore, the seal member 31C is in intimate contact with the inner peripheral surface of the tubular portion 92 and the outer peripheral surface of the case mating portion 43 in a liquid-tight manner. Accordingly, it is possible to effectively prevent the interior of the case 90 from being exposed to water from the second connector 12.

As described above, the connector 10 according to the first embodiment includes the first connector 11 and the second connector 12. The first connector 11 includes the first housing 13 and the lever 14 rotatably supported by the first housing 13. The second connector 12 includes the second housing 16 that is mateable with the first housing 13. The lever 14 includes the cam plates 36 that engage with the second housing 16. A portion of the second housing 16 is disposed inside the tubular portion 92 of the case 90. The first housing 13 (the outer housing 19) includes the first housing body 22 (housing body), the extended portion 26 extending outward from the leading end portion (lower end portion) of the first housing body 22 in the mating direction of the first housing 13, and the peripheral wall portion 30 protruding in the mating direction from the outer end portion of the extended portion 26. The tubular portion 92 is disposed in a space on the inner side of the peripheral wall portion 30 and forward of the extended portion 26 in the mating direction (below the extended portion 26). The first housing 13 includes the upright walls 29 protruding in a direction opposite to the mating direction (upward) from the outer end portion of the extended portion 26. The cam plates 36 are each disposed to be sandwiched between the first housing body 22 and the corresponding upright walls 29. Accordingly, the extended portion 26 has a function of preventing the cam plates 36 from opening and a function of mating with the case 90, making it possible to simplify the structure compared with a configuration in which those functions are provided by separate structures.

The cam plates 36 respectively engage with the cam pins 46 of the second housing 16. The through holes 27 through which the cam pins 46 are inserted are formed in the extended portion 26. A pair of upright walls 29 are disposed on the front and rear sides of each through hole 27. In the entire rotation process of the lever 14 from a start of mating between the first housing 13 and the second housing 16 to completion of the mating, the cam plates 36 are each disposed to be sandwiched between the first housing body 22 and the corresponding pair of upright walls 29. The pair of upright walls 29 with the through hole 27 therebetween always face the cam plate 36 in a contactable manner, and thus, for example, even when the angle of rotation of the lever is limited and an expanding force acting on the cam plates 36 becomes large, the upright walls 29 can maximally prevent the cam plates 36 from opening. In addition, for example, even when the electric wire cover is changed, the lever 14 can also be attached to the outer housing 19 if the lever 14 is reversed in the left-right direction. As shown in FIG. 11, also when attaching, to the outer housing 19, the electric wire cover 21A having a different shape from that of the electric wire cover 21, the lever 14 can be applied. That is, even when the electric wire cover is changed, the change can be handled without changing the shapes of the lever 14 and the outer housing 19.

The upright walls 29 gradually narrow in width from the base ends thereof connected to the extended portion 26 to the leading ends in the protruding direction (upper ends). Accordingly, even in a state where the lever 14 is at the initial mating position, it is possible to prevent interference between the lever 14 and the upright walls 29. Particularly, it is possible to prevent interference with the inclined surfaces 49 of the lever 14. In addition, since the base ends of the upright walls 29 are wider than the leading ends, the strength of the upright walls 29 can be secured.

The outer surfaces of the upright walls 29 are formed along the arc shape of the outer peripheral surface of the peripheral wall portion 30 as viewed in the mating direction (from above). The inner surfaces of the upright walls 29 are formed linearly along a direction orthogonal to the mating direction (front-rear direction) as viewed in the mating direction. Accordingly, the plate thickness of the upright walls can be increased compared with a case where the outer surfaces of upright walls are formed linearly along the front-rear direction, and thus the strength of the upright walls 29 can be improved.

### Other Embodiments of the Present Disclosure

The embodiment disclosed herein is an example in all respects and should not be interpreted as limiting in any manner.

In the first embodiment, the case 90 is made by aluminium die casting. In contrast, in another embodiment, the case may be formed from a metal plate or the like instead of aluminium die casting.

In the first embodiment, the upright walls 29 are formed to gradually narrow in width from the base ends to the leading ends. In contrast, in another embodiment, the upright walls do not need to gradually narrow in width from the base ends to the leading ends. Specifically, the widths of the base ends and leading ends may be the same.

In the first embodiment, the recesses 48 are provided in the outer surfaces of the upright walls 29. In contrast, in another embodiment, recesses do not need to be provided in the outer surfaces of the upright walls.

In the first embodiment, the first connector 11 is a female connector that accommodates the first terminal fittings 15 that are female terminals, and the second connector 12 is a male connector that accommodates the second terminal fittings 17 that are male terminals. In contrast, in another embodiment, the male-female relationship between the first connector and first terminal fittings and the second connector and second terminal fittings may be reversed. Specifically, the first connector may be a male connector that accommodates first terminal fittings that are male terminals, and the second connector may be a female connector that accommodates second terminal fittings that are female terminals.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a first connector; and
a second connector,
wherein the first connector includes a first housing and a lever rotatably supported by the first housing,
the second connector includes a second housing that is mateable with the first housing,
the lever includes a cum plate that engages with the second housing,
a portion of the second housing is disposed inside a tubular portion of a case,
the first housing includes a housing body, an extended portion extending outward from a leading end portion of the housing body in a mating direction of the first housing, and a peripheral wall portion protruding in the mating direction from an outer end portion of the extended portion,
the tubular portion is disposed in a space on an inner side of the peripheral wall portion and forward of the extended portion in the mating direction,
the first housing has an upright wall protruding from the outer end portion of the extended portion in a direction opposite to the mating direction, and
the cam plate is disposed to be sandwiched between the upright wall and the housing body.

2. The connector according to claim 1,
wherein the cam plate engages with a cam pin of the second housing,
a through hole into which the cam pin is inserted is formed in the extended portion,
a pair of upright walls are disposed on opposite sides of the through hole, and
the cam plate is disposed to be sandwiched between the housing body and the pair of upright walls during an entire rotation process of the lever from a start of mating between the first housing and the second housing to completion of the mating.

3. The connector according to claim 2,
wherein each of the upright walls gradually narrows in width from a base end thereof connected to the extended portion to a leading end in a protruding direction.

4. The connector according to claim 1,
wherein outer surfaces of the upright walls are formed along an arc shape of an outer peripheral surface of the peripheral wall portion as viewed in the mating direction, and inner surfaces of the upright walls are formed linearly along a direction orthogonal to the mating direction as viewed in the mating direction.
